(19) United States
(12) Patent Application Publication
(10) Pub. No.: US 2016/0127956 A1
(43) Pub. Date: May 5, 2016

(54) SYSTEMS AND METHODS FOR INTER-RADIO ACCESS TECHNOLOGY RESELECTION

(71) Applicant: QUALCOMM Incorporated, San Diego, CA (US)

(72) Inventors: Siva Kumar Jujaray, San Diego, CA (US); Mungal Singh Dhanda, Slough (GB); Madhusudan Kinthada Venkata, San Diego, CA (US)

(21) Appl. No.: 14/527,442

(22) Filed: Oct. 29, 2014

(51) Int. Cl. H04W 36/00; H04W 36/30

(52) U.S. Cl. CPC H04W 36/0066; H04W 36/0094; H04W 36/30; H04W 88/06

(57) ABSTRACT

A method for cell reselection by a wireless communication device is described. The method includes signal strength of cells in one or more inter-radio access technology (inter-RAT) frequencies while camped on a serving cell in a connected mode. On releasing the connected mode and before moving to idle mode on the serving cell, the method also includes prioritizing the cells in the one or more inter-RAT frequencies based on a RAT preference order and the signal strength. The method further includes reselecting to a highest priority cell whose signal strength meets a cell selection criterion.

### TECHNICAL FIELD

The present disclosure relates generally to communication systems. More specifically, the present disclosure relates to systems and methods for inter-radio access technology (inter-RAT) reselection.

### BACKGROUND

Wireless communication systems have become an important means by which many people worldwide have come to communicate. A wireless communication system may provide communication for a number of wireless communication devices, each of which may be serviced by one or more base stations.

Sometimes a wireless communication device will switch from one cell to a target cell. This may be referred to as cell reselection. In some cases, cells may be available on multiple radio access technologies (RATs). Benefits may be realized by prioritizing RATs for cell reselection. Additional benefits may be realized by determining the best cell for reselection when multiple cells are available.

### SUMMARY

A method for cell reselection is described. The method includes measuring signal strength of cells in one or more inter-radio access technology (inter-RAT) frequencies while camped on a serving cell in a connected mode. On releasing the connected mode and before moving to idle mode on the serving cell, the method also includes prioritizing the cells in the one or more inter-RAT frequencies based on a RAT preference order and the signal strength. The method further includes reselecting to a highest priority cell whose signal strength meets a cell selection criterion.

The connected mode may include a dedicated mode or a packet transfer mode. The RAT preference order may rank multiple RATs from most-preferred RAT to least-preferred RAT for inter-RAT cell reselection. The RAT preference order may be user-defined or preconfigured by a wireless communication device manufacturer. The serving cell may be a shared cell.

Prioritizing the cells in the one or more inter-RAT frequencies may include sorting the cells in the one or more inter-RAT frequencies into one or more RAT groups. Cells belonging to the same RAT may be included in the same RAT group. The one or more RAT groups may be sorted according to the RAT preference order. A more-preferred RAT may have a higher priority than a less-preferred RAT. Cells within each RAT group may be sorted according to signal strength. A cell with a higher signal strength may have a higher priority than a cell with a lower signal strength.

The method may also include reselecting to the highest priority cell when the highest priority cell belongs to a more-preferred RAT than the RAT of the serving cell.

The method may also include camping back on the serving cell if reselecting to one or more target cells on a more-preferred RAT fails before expiration of a reselection timer.

If the serving cell belongs to a most-preferred RAT, then upon radio link failure (RLF) and when there are no available cells belonging to the most-preferred RAT, the method may also include reselecting to the highest priority cell belonging to a less-preferred RAT without performing a band scan on the less-preferred RAT.

A wireless communication device for cell reselection is also described. The wireless communication device includes a processor, memory in electronic communication with the processor, and instructions stored in the memory. The instructions are executable by the processor to measure signal strength of cells in one or more inter-RAT frequencies while camped on a serving cell in a connected mode. On releasing the connected mode and before moving to idle mode on the serving cell, the instructions are also executable to prioritize the cells in the one or more inter-RAT frequencies based on a RAT preference order and the signal strength. The instructions are further executable to reselect to a highest priority cell whose signal strength meets a cell selection criterion.

An apparatus for cell reselection is also described. The apparatus includes means for measuring signal strength of cells in one or more inter-RAT frequencies while camped on a serving cell in a connected mode. The apparatus also includes means for prioritizing the cells in the one or more inter-RAT frequencies based on a RAT preference order and the signal strength on releasing the connected mode and before moving to idle mode on the serving cell. The apparatus further includes means for reselecting to a highest priority cell whose signal strength meets a cell selection criterion.

A computer-program product for cell reselection is also described. The computer-program product includes a non-transitory computer-readable medium having instructions thereon. The instructions include code for causing a wireless communication device to measure signal strength of cells in one or more inter-RAT frequencies while camped on a serving cell in a connected mode. The instructions also include code for causing the wireless communication device to prioritize the cells in the one or more inter-RAT frequencies based on a RAT preference order and the signal strength on releasing the connected mode and before moving to idle mode on the serving cell. The instructions further include code for causing the wireless communication device to reselect to a highest priority cell whose signal strength meets a cell selection criterion.

### BRIEF DESCRIPTION OF THE DRAWINGS

FIG. 1 is a block diagram illustrating a wireless communication system with a wireless communication device, a serving cell and one or more neighbor cells;

FIG. 2 is a flow diagram of a method for inter-radio access technology (inter-RAT) reselection;

FIG. 3 is a flow diagram of a method for prioritizing cells in one or more inter-RAT frequencies;

FIG. 4 illustrates configurations of a RAT preference order and an inter-RAT cell priority list;

FIG. 5 is a flow diagram illustrating a detailed configuration of a method for inter-RAT reselection;

FIG. 6 is a flow diagram illustrating a detailed configuration of a method for inter-RAT reselection; and

FIG. 7 illustrates certain components that may be included within a wireless communication device.

### DETAILED DESCRIPTION

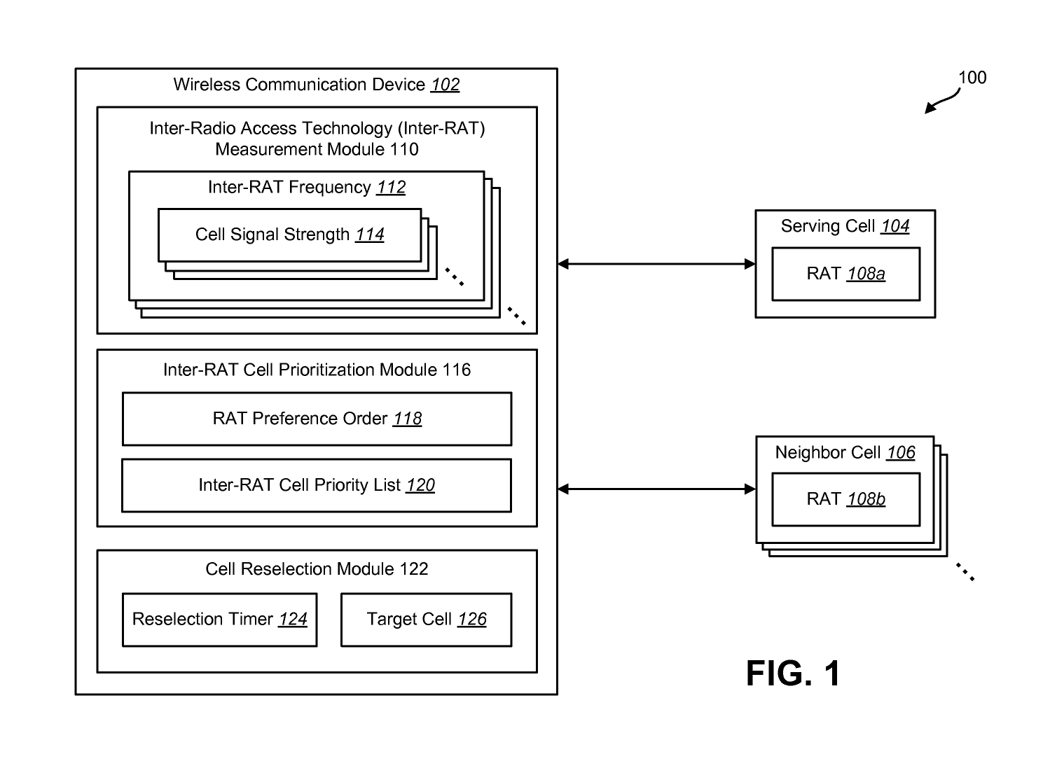

FIG. 1 is a block diagram illustrating a wireless communication system 100 with a wireless communication device 102, a serving cell 104 and one or more neighbor cells 106. Wireless communication systems 100 are widely deployed to provide various types of communication content such as voice, data, and so on. Inter-radio access technology (inter-RAT) cell reselection may be performed on the wireless communication system 100 according to the systems and methods described herein.

The serving cell 104 and the one or more neighbor cells 106 may be provided by a base station. The term “cell” can refer to a base station and/or the coverage area of a base station depending on the context in which the term is used. A base station is a station that may communicate with one or more wireless communication devices 102. A base station may also be referred to as, and may include some or all of the functionality of an access point, a broadcast transmitter, a NodeB, an evolved NodeB, a base transceiver station, etc. The term “base station” will be used herein. Each base station may provide communication coverage for a particular geographic area. A base station may provide communication coverage for one or more wireless communication devices 102.

A base station may provide one or more cells. For example, a first base station may provide a serving cell 104 and a second base station may provide a neighbor cell 106. In another configuration, a single base station may provide both a serving cell 104 and one or more neighbor cells 106.

In some configurations, the serving cell 104 may be a shared cell. In a network that supports network sharing, the network may broadcast network sharing information that indicates the core network operators sharing a radio access network. The wireless communication device 102 may use the network sharing information for cell reselection.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may also be referred to as a “network” or “wireless network.” The wireless communication system 100 may utilize MIMO. A MIMO system may support both time division duplex (TDD) and frequency division duplex (FDD) systems. In a TDD system, uplink and downlink transmissions are on the same frequency region so that the reciprocity principle allows the estimation of the downlink channel from the uplink channel. This enables a transmitting wireless device (e.g., wireless communication device 102 or base station) to extract transmit beamforming gain from communications received by the transmitting wireless device.

The wireless communication system 100 may be a multiple-access system capable of supporting communication with multiple wireless communication devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE) and UMTS, a wireless communication device 102 may be referred to as a “user equipment” (UE). In 3GPP Global System for Mobile Communications (GSM), a wireless communication device 102 may be referred to as a “mobile station” (MS). A wireless communication device 102 may also be referred to as, and may include some or all of the functionality of, a terminal, an access terminal, a subscriber unit, a station, etc. A wireless communication device 102 may be a cellular phone, a personal digital assistant (PDA), a wireless device, a wireless modem, a handheld device, a laptop computer, a Session Initiation Protocol (SIP) phone, a wireless local loop (WLL) station, an appliance (e.g., dishwasher, refrigerator, laundry machine, etc.), a sensor, a wearable computing device (e.g., a smartwatch, a health or fitness tracker, etc.), a vending machine, etc.

A wireless communication device 102 may communicate with zero, one or multiple base stations on the downlink and/or uplink at any given moment. The downlink (or forward link) refers to the communication link from a base station to a wireless communication device 102, and the uplink (or reverse link) refers to the communication link from a wireless communication device 102 to a base station.

A wireless communication device 102 may be capable of communicating with the one or more base stations 104 as part of one or more communication systems 100. A system 100 may utilize one or more radio access technologies (RATs) 108. Examples of RATs 108 include CDMA2000 lx (also known as lx), Global System for Mobile Communications (GSM), GSM/EDGE Radio Access Network (GERAN), High Data Rate (HDR), High Rate Packet Data (HRPD), evolved High Rate Packet Data (eHRPD), Wideband Code Division Multiple Access (W-CDMA), Time Division Synchronous Code Division Multiple Access (TD-SCDMA) and Long Term Evolution (LTE). One or more of the systems 100 may utilize different types of RATs 108. For example, a first system 100 may utilize a RAT 108 that may include a GERAN network. In this example, a second system 100 may utilize a RAT 108 that may include an LTE network.

The wireless communication device 102 may be camped on the serving cell 104. The term “camp” refers to a process in which the wireless communication device 102 monitors a cell for system information and paging information. The wireless communication device 102 may receive paging information on a paging channel. The cell on which the wireless communication device 102 is camped is referred to as the serving cell 104.

The wireless communication device 102 may be configured to communicate with multiple RATs 108. For example, a serving cell 104 may have one RAT 108a and the neighbor cells 106 may have the same or different RATs 108b. In some cases, the wireless communication device 102 may perform cell reselection from a serving cell 104 of one RAT 108 to a neighbor cell 106 of another RAT 108. For example, the wireless communication device 102 may be camped on a serving cell 104 whose RAT 108a is GERAN. The wireless communication device 102 may perform a cell reselection to a neighbor cell 106 whose RAT 108b is LTE. The process of performing cell reselection to a neighbor cell 106 that has a different RAT 108 than the serving cell 104 is referred to as inter-RAT cell reselection.

While camped on the serving cell 104, the wireless communication device 102 may be in a connected mode. For instance, the wireless communication device 102 may enter the connected mode when performing a voice call or data call. For a voice call, the connected mode may be a dedicated mode. For a data call, the connected mode may be a packet transfer mode.

While in connected mode, the wireless communication device 102 may receive one or more inter-RAT frequencies 112 from the network. The network may send information relating to inter-RAT frequencies 112 to the wireless communication device 102.

Each inter-RAT frequency 112 may be associated with a RAT 108 and one or more cells. Therefore, an inter-RAT frequency 112 refers to the cells within that inter-RAT frequency 112. Each cell in an inter-RAT frequency 112 may be differentiated by a particular physical cell identification (ID). Therefore, a particular cell may be identified by its physical cell identification and frequency. A cell in an inter-RAT frequency 112 may also be referred to as an inter-RAT cell. One or more neighbor cells 106 operating with a particular RAT 108b may be within an inter-RAT frequency 112. For instance, a neighbor cell 106 may be an LTE cell or a GERAN cell, etc. Each cell associated with an inter-RAT frequency 112 may have a corresponding signal strength 114.

In one configuration, the wireless communication device 102 may include an inter-RAT measurement module 110 that measures the inter-RAT frequencies 112. While in connected mode, the inter-RAT measurement module 110 may measure the signal strengths 114 of the cells within an inter-RAT frequency 112. The network may provide details of the cells in both intra-RAT and inter-RAT frequencies 112. In one configuration, the inter-RAT measurement module 110 may measure the reference signal receive power (RSRP), the received signal strength indicator (RSSI) or the received signal code power (RSCP) of a neighbor cell 106. The inter-RAT measurement module 110 may measure the power of a received signal. The cell signal strength 114 may include an RSRP, RSSI, RSCP or other parameter that indicates the power of a signal received from a cell.

The wireless communication device 102 may send measurement reports for the inter-RAT frequencies 112 to the network on a signaling channel. In connected mode, the network may control the mobility (e.g., handover, cell change order or redirection) of the wireless communication device 102.

If the wireless communication device 102 has performed a mobility operation in connected mode, the wireless communication device 102 may camp on a new serving cell 104. After the mobility operation, the wireless communication device 102 may not have information about the neighbor cells 106 of the new serving cell 104, or the information about the neighbor cells 106 may be stale.

In one approach to addressing these problems, the wireless communication device 102 may acquire (or reacquire) system information for the neighbor cells 106. However, acquiring or reacquiring this information may take a long time. Moreover, even after acquiring or reacquiring this information, the wireless communication device 102 may still end up performing cell reselection to a cell in an inter-RAT frequency 112 the wireless communication device 102 already measured when the wireless communication device 102 was in connected mode.

These problems may be more severe if the wireless communication device 102 is a legacy device on a shared network. In this case, the wireless communication device 102 may be left to go out of service (OOS) or may be forced to wait for a home public land mobile network (HPLMN) search timer to expire before the wireless communication device 102 reselects to the HPLMN. This may occur even if the wireless communication device 102 has knowledge of the HPLMN inter-RAT frequency 112 from when the wireless communication device 102 was in connected mode.

To avoid this lengthy delay, the wireless communication device 102 may utilize the inter-RAT frequencies 112 measured while in connected mode. The wireless communication device 102 may include an inter-RAT cell prioritization module 116 that may prioritize cells from one or more inter-RAT frequencies 112 for reselection.

The inter-RAT cell prioritization module 116 may include a RAT preference order 118 that ranks multiple RATs 108 from most-preferred RAT 108 to least-preferred RAT 108 for inter-RAT cell reselection. In one configuration, the RAT preference order 118 may be user-defined. For example, a user of the wireless communication device 102 may enter the preferred order of RATs 108 to which the wireless communication device 102 may attempt reselection. The user may enter the RAT preference order 118 through a user-interface, for instance. In one example, the RAT preference order 118 may be that LTE is the most-preferred RAT 108, followed by WCDMA and GERAN.

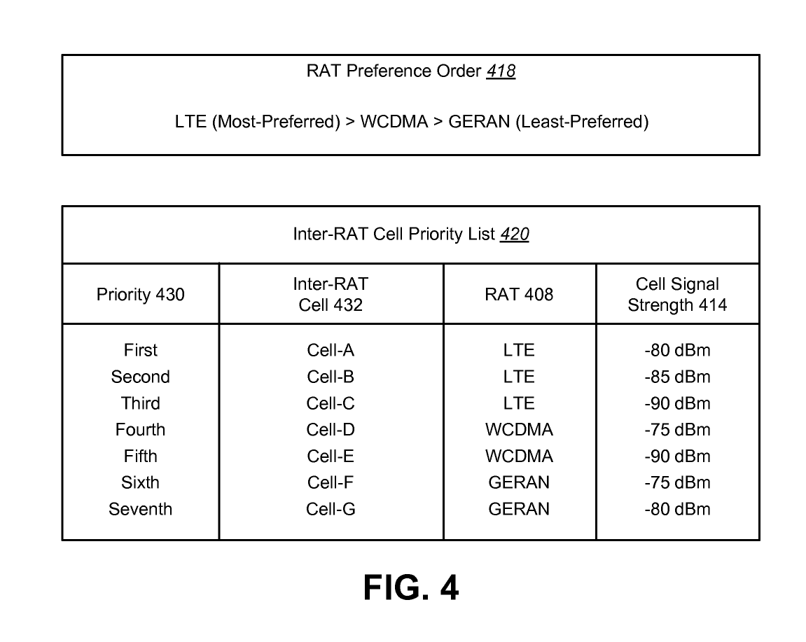

In another configuration, the RAT preference order 118 may be preconfigured by the manufacturer of the wireless communication device 102 or a network provider. A user may or may not be allowed to subsequently change the preconfigured RAT preference order 118. An example of a RAT preference order 118 is described in connection with FIG. 4.

Upon release of the connected mode and before moving to idle mode on the serving cell 104, the inter-RAT cell prioritization module 116 may prioritize cells in the inter-RAT frequencies 112 based on the RAT preference order 118 and cell signal strength 114. The inter-RAT cell prioritization module 116 may check if any inter-RAT cells were measured while in connected mode. If there are measured cell signal strengths 114, the inter-RAT cell prioritization module 116 may sort the cells in the inter-RAT frequencies 112 based on the RAT preference order 118 and cell signal strength 114.

In one configuration, the cells in the inter-RAT frequencies 112 may be grouped according RAT 108, where cells belonging to the same RAT 108 are included in the same RAT group. The one or more groups of RATs 108 may be sorted according to the RAT preference order 118. A more-preferred RAT 108 may have a higher priority than a less-preferred RAT 108. The cells within each group of RATs 108 may then be sorted according to signal strength 114. A cell with a higher signal strength 114 (e.g., a higher signal strength cell) may have a higher priority than a cell with a lower signal strength 114 (e.g., a lower signal strength cell).

The inter-RAT cell prioritization module 116 may produce an inter-RAT cell priority list 120 of the prioritized inter-RAT cells. In one configuration, the inter-RAT cell priority list 120 may classify the inter-RAT cells from highest priority cell to lowest priority cell. In another configuration, the inter-RAT cell priority list 120 may classify the inter-RAT cells from lowest priority cell to highest priority cell. An example of an inter-RAT cell priority list 120 is described in connection with FIG. 4.

A cell reselection module 122 may perform cell reselection based on the inter-RAT cell priority. The cell reselection module 122 may attempt to reselect to a target cell 126 that is the highest priority cell whose signal strength 114 meets a cell selection criterion for a target cell 126. The priority of the target cell 126 may be determined from the inter-RAT cell priority list 120. In one configuration, the cell selection criterion may be an S criterion. The S criterion may be determined according to Equation (1).

In Equation (1), Sᵣₓₗₑᵥ is the cell selection receive (RX) level value in decibels (dB). Sᵣₓₗₑᵥ may be defined according to Equation (2). S_{qual} is the cell selection quality value in decibels (dB). S_{qual} may be defined according to Equation (3).

Sᵣₓₗₑᵥ=Qᵣₓₗₑᵥₘₑₐₛ−(Q_{rvlev min}+Q_{rxlev min offset})−P_{compensation} (2)

S_{qual}=Q_{qualmeas}−(Q_{qual min}+Q_{qual min offset}) (3)

In Equations (2) and (3), Qᵣₓₗₑᵥₘₑₐₛ is the measured cell RX level value (e.g., RSRP). Q_{qualmeas} is the measured cell quality value (e.g., RSRQ). Qᵣₓₗₑᵥₘᵢₙ is the minimum required RX level in the cell (dBm). Q_{qualmin} is the minimum required quality level in the cell (dB). Q_{rlexvminoffset} is the offset to the signaled Qᵣₓₗₑᵥₘᵢₙ taken into account in the Sᵣₓₗₑᵥ evaluation as a result of a periodic search for a higher priority PLMN while camped normally in a VPLMN. Q_{qualminoffset} is the offset to the signaled Q_{qualmin} taken into account in the S_{qual} evaluation as a result of a periodic search for a higher priority PLMN while camped normally in a VPLMN. P _{compensation} is defined as max(PEMAX−PPowerClass,0) (dB). PEMAX is the maximum TX power level a wireless communication device 102 may use when transmitting on the uplink in the cell (dBm). PPowerClass is the maximum radio frequency (RF) output power of the wireless communication device 102 (dBm) according to the power class of the wireless communication device 102.

The cell reselection module 122 may attempt to reselect to the highest priority cell when the highest priority cell belongs to a more-preferred RAT 108 than the RAT 108 of the serving cell 104. For example, the cell reselection module 122 may determine whether the cell signal strength 114 of the highest priority cell meets the cell selection criterion for the RAT 108 of the target cell 126. If the cell selection criterion is met, the cell reselection module 122 may perform reselection to the target cell 126. If the reselection is successful, the wireless communication device 102 may camp on the target cell 126.

In the event that reselection to a target cell 126 is unsuccessful, the cell reselection module 122 may make one or more attempts to camp on a target cell 126 on a more-preferred RAT before the expiration of the reselection timer 124. For example, the cell reselection module 122 may attempt to reselect to the next highest priority cell as indicated by the inter-RAT cell priority list 120. If this reselection attempt fails, the cell reselection module 122 may attempt yet another reselection on a target cell 126 with the next highest priority, and so on until the reselection timer 124 expires. The wireless communication device 102 may camp back on the serving cell 104 if reselecting to one or more target cells 126 on a more-preferred RAT fails before expiration of a reselection timer 124.

In one configuration, the reselection timer 124 is a Tᵢᵣₐₜᵣₑₛₑₗ timer. The reselection timer 124 may be started upon release of the connected mode (e.g., on call release). The reselection timer 124 may be selected such that it does not cause large delays in camping on the target cell 126. This may help avoid mobile-terminated (MT) call failures.

In some cases, the serving cell 104 may belong to the most-preferred RAT 108 (as indicated by the RAT preference order 118) and there may not be any available neighbor cells 106 belonging to that most-preferred RAT 108. In this scenario, if a radio link failure (RLF) with the serving cell 104 occurs, the wireless communication device 102 may reselect to the highest priority cell belonging to a less-preferred RAT 108 without performing a band scan on the less-preferred RAT 108.

The described systems and methods provide for an efficient method for inter-RAT reselection to a higher priority RAT 108 based on signal strengths 114 on release of connected mode. The described systems and methods may provide a better user experience. For example, the wireless communication device 102 may be able to camp on the best possible RAT 108 (when available) more quickly. The described systems and methods may also reduce network congestion because the wireless communication device 102 may avoid having to perform a location area update (LAU)/routing area update (RAU) procedure on the serving cell 104 followed by potential cell reselection to a new RAT 108 and another RAU/tracking area update (TAU) on the target cell 126.

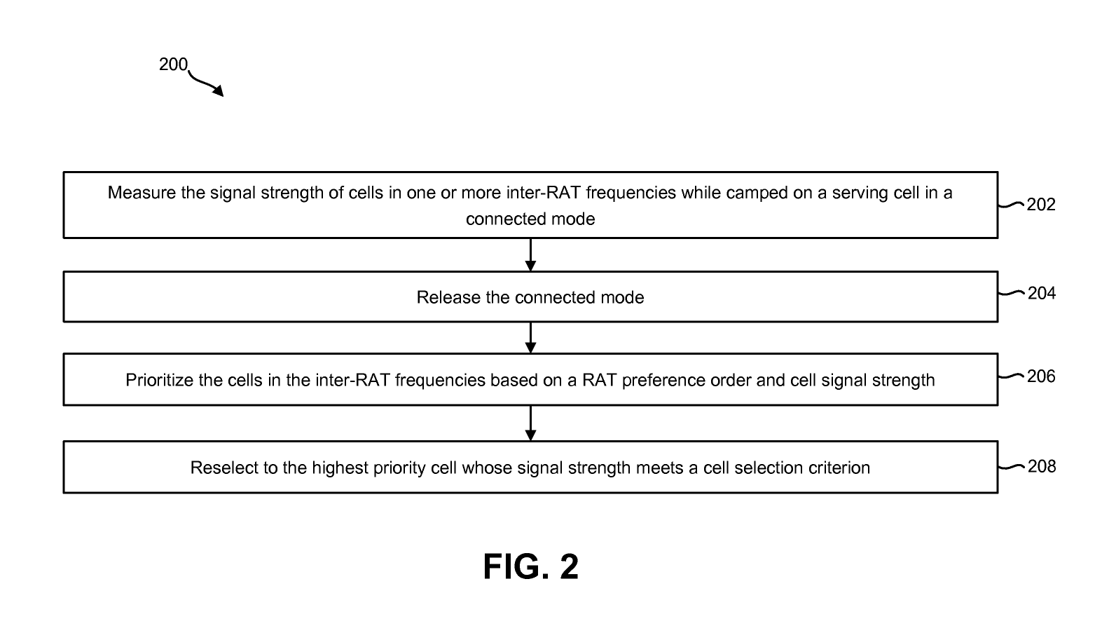

FIG. 2 is a flow diagram of a method 200 for inter-RAT reselection. The method 200 may be performed by a wireless communication device 102. The wireless communication device 102 may be camped on a serving cell 104.

The wireless communication device 102 may measure 202 the signal strength 114 of cells in one or more inter-RAT frequencies 112 while camped on the serving cell 104 in connected mode. For example, while making a voice call or data call, the wireless communication device 102 may measure the signal strength 114 of a cell in an inter-RAT frequency 112. There may be one or more cells associated with an inter-RAT frequency 112. Therefore, the wireless communication device 102 may measure one or more cell signal strengths 114 for each inter-RAT frequency 112. The wireless communication device 102 may measure the power of a received signal from a neighbor cell 106. In one configuration, the signal strength 114 may be an RSRP, RSSI or RSCP of the neighbor cell 106.

The wireless communication device 102 may release 204 the connected mode. Before moving to idle mode on the serving cell 104, the wireless communication device 102 may prioritize 206 the cells in the inter-RAT frequencies 112 based a RAT preference order 118. The wireless communication device 102 may sort the cells in the inter-RAT frequencies 112 based on the RAT preference order 118 and cell signal strength 114.

The RAT preference order 118 may rank multiple RATs 108 from most-preferred RAT 108 to least-preferred RAT 108 for inter-RAT cell reselection. In one configuration, the RAT preference order 118 may be user-defined. In another configuration, the RAT preference order 118 may be preconfigured by the manufacturer of the wireless communication device 102 or a network provider. A user may or may not be allowed to subsequently change the preconfigured RAT preference order 118. An example of a RAT preference order 118 is described in connection with FIG. 4.

In one configuration, the inter-RAT frequencies 112 may be grouped according RAT 108, where inter-RAT frequencies 112 belonging to the same RAT 108 are included in the same RAT group. The one or more groups of RATs 108 may be sorted according to the RAT preference order 118. A more-preferred RAT 108 may have a higher priority than a less-preferred RAT 108. The cells within each group of RATs 108 may then be sorted according to signal strength 114. A cell with a higher signal strength 114 may have a higher priority than a cell with a lower signal strength 114.

The wireless communication device 102 may produce an inter-RAT cell priority list 120 of the prioritized inter-RAT cells. In one configuration, the inter-RAT cell priority list 120 may classify the inter-RAT cells from highest priority cell to lowest priority cell. In another configuration, the inter-RAT cell priority list 120 may classify the inter-RAT cells from lowest priority cell to highest priority cell.

The wireless communication device 102 may reselect 208 to the highest priority cell whose signal strength 114 meets a cell selection criterion. In other words, the wireless communication device 102 may attempt to reselect 208 to a target cell 126 that is the highest priority cell as indicated by the inter-RAT cell priority list 120. In one configuration, the cell selection criterion may be an S criterion.

The wireless communication device 102 may attempt to reselect 208 to the target cell 126 when the target cell 126 belongs to a more-preferred RAT 108 than the RAT 108 of the serving cell 104. For example, the wireless communication device 102 may determine whether the cell signal strength 114 of the target cell 126 meets the cell selection criterion for the RAT 108 of the target cell 126. If the cell selection criterion is met, the wireless communication device 102 may perform reselection to the target cell 126. If the reselection is successful, the wireless communication device 102 may camp on the target cell 126.

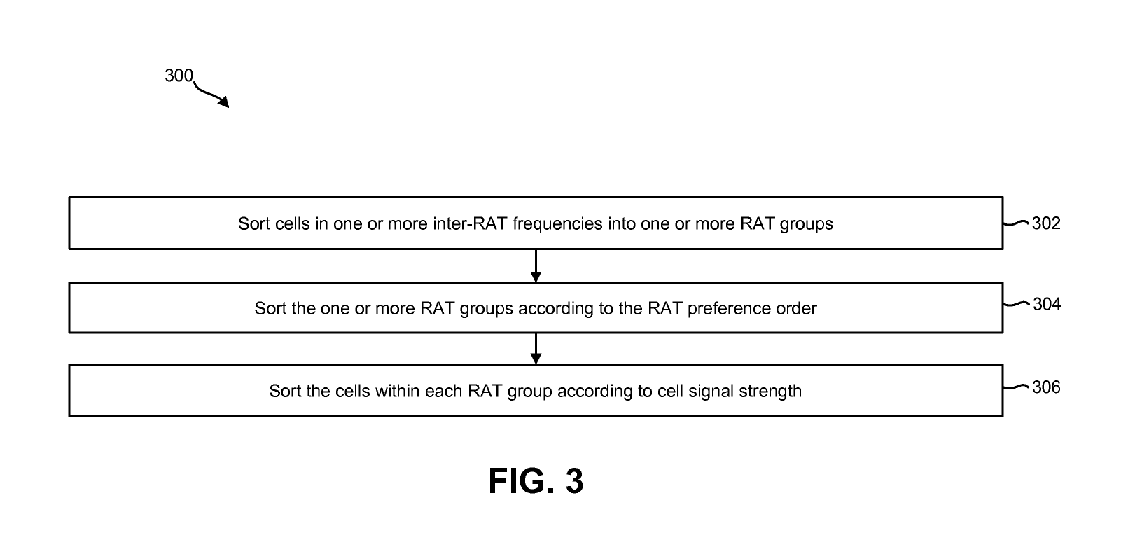

FIG. 3 is a flow diagram of a method 300 for prioritizing cells in one or more inter-RAT frequencies 112. The method 300 may be performed by a wireless communication device 102 upon releasing a connected mode. The wireless communication device 102 may be camped on a serving cell 104. While in connected mode, the wireless communication device 102 may measure the signal strength 114 of cells in one or more inter-RAT frequencies 112. For example, the wireless communication device 102 may measure the signal strength 114 of the cells within the inter-RAT frequencies 112.

Upon releasing the connected mode, the wireless communication device 102 may sort 302 the cells in the one or more inter-RAT frequencies 112 into one or more RAT groups. The cells belonging to the same RAT 108 may be included in the same RAT group. For example, cells belonging to LTE may be sorted into an LTE group. Cells belonging to WCDMA may be sorted into a WCDMA group and so forth.

The wireless communication device 102 may sort 304 the one or more RAT groups according to a RAT preference order 118. The RAT preference order 118 may rank multiple RATs 108 from most-preferred RAT 108 to least-preferred RAT 108 for inter-RAT cell reselection. The RAT preference order 118 may be user-defined or may be configured by the manufacturer or provider of the wireless communication device 102.

A more-preferred RAT 108 may have a higher priority than a less-preferred RAT 108. For example, the RAT preference order 118 may indicate that LTE is more preferred than WCDMA. Therefore, the inter-RAT frequencies 112 within the LTE group may have a higher priority than the inter-RAT frequencies 112 within the WCDMA group.

The wireless communication device 102 may sort 306 the cells within each RAT group according to signal strength 114. The wireless communication device 102 may give a cell with a higher signal strength 114 a higher priority than a cell with a lower signal strength 114. For example, the wireless communication device 102 may rank cells in an LTE group from high to low cell signal strength 114. Similarly, the wireless communication device 102 may rank cells in a WCDMA group from high to low cell signal strength 114.

The wireless communication device 102 may produce an inter-RAT cell priority list 120 of the prioritized inter-RAT cells. For example, the ranked cells of the most-preferred RAT 108 may be listed first, followed by the cells of less-preferred RATs 108.

FIG. 4 illustrates configurations of a RAT preference order 418 and an inter-RAT cell priority list 420. The RAT preference order 418 and the inter-RAT cell priority list 420 may be stored in a wireless communication device 102, as described in connection with FIG. 1.

The RAT preference order 418 the RAT preference order 418 may be user-defined or preconfigured (e.g., by the manufacturer of the wireless communication device 102 or a network provider). The RAT preference order 418 may rank multiple RATs 408 from most-preferred RAT 408 to least-preferred RAT 408 for inter-RAT cell reselection.

In the example illustrated in FIG. 4, the RAT preference order 418 ranks LTE, WCDMA and GERAN. In this example, LTE is the most-preferred RAT 408 followed by WCDMA. GERAN is the least-preferred RAT 408. Therefore, the RAT preference order 418 indicates that the wireless communication device 102 should prioritize LTE cells above WCDMA cells. Similarly, the wireless communication device 102 should prioritize WCDMA cells above GERAN cells.

The inter-RAT cell priority list 420 may be produced by the wireless communication device 102 based on the RAT preference order 418 and measured cell signal strengths 414. The wireless communication device 102 may measure the cell signal strengths 414 associated with cells in one or more inter-RAT frequencies 112 while in connected mode. Upon release of the connected mode, the wireless communication device 102 may prioritize the inter-RAT cells 432 to produce the inter-RAT cell priority list 420. In one configuration, the inter-RAT cells 432 may be prioritized as described in connection with FIG. 3.

In the example illustrated in FIG. 4, seven cells (i.e., inter-RAT cells 432) in inter-RAT frequencies 112 are prioritized. The inter-RAT cells 432 are ranked from a highest priority 430 (i.e., first priority) to the lowest priority 430 (i.e., seventh priority). Based on the RAT preference order 418, the cells in the LTE inter-RAT frequencies 112 (i.e., Cell-A, Cell-B and Cell-C) have a higher priority 430 than the cells in the WCDMA and GERAN inter-RAT frequencies 112. Similarly, the cells in the WCDMA inter-RAT frequencies 112 (i.e., Cell-D and Cell-E) have a higher priority 430 than the cells in the GERAN inter-RAT frequencies 112 (i.e., Cell-F and Cell-G).

The inter-RAT frequencies 112 within each RAT group are further prioritized according for cell signal strength 414. For example, because Cell-A has a higher cell signal strength 414 than Cell-B and Cell-C, Cell-A has a higher priority 430 than the other cells in the LTE inter-RAT frequencies 112. The cells in the WCDMA and GERAN inter-RAT frequencies 112 are similarly prioritized according to cell signal strength 414.

It should be noted that a cell in an inter-RAT frequency 112 may have a higher cell signal strength 414 than a cell in another inter-RAT frequency 112, but may have a lower priority 430 due to the RAT preference order 418. For example, Cell-D has a higher cell signal strength 414 than Cell-A, Cell-B and Cell-C. However, Cell-D belongs to WCDMA, which is a less-preferred RAT 408 than LTE according to the RAT preference order 418. Therefore, Cell-D has a lower priority than Cell-A, Cell-B and Cell-C.

It should also be noted that the inter-RAT cell priority list 420 may take a different form than the example illustrated in FIG. 4. For example, in one configuration, the inter-RAT cell priority list 420 may only include a priority 430 and RAT 408 for each inter-RAT frequency 112. In another configuration, the inter-RAT cell priority list 420 may only include the inter-RAT cells 432 listed from highest priority to lowest priority.

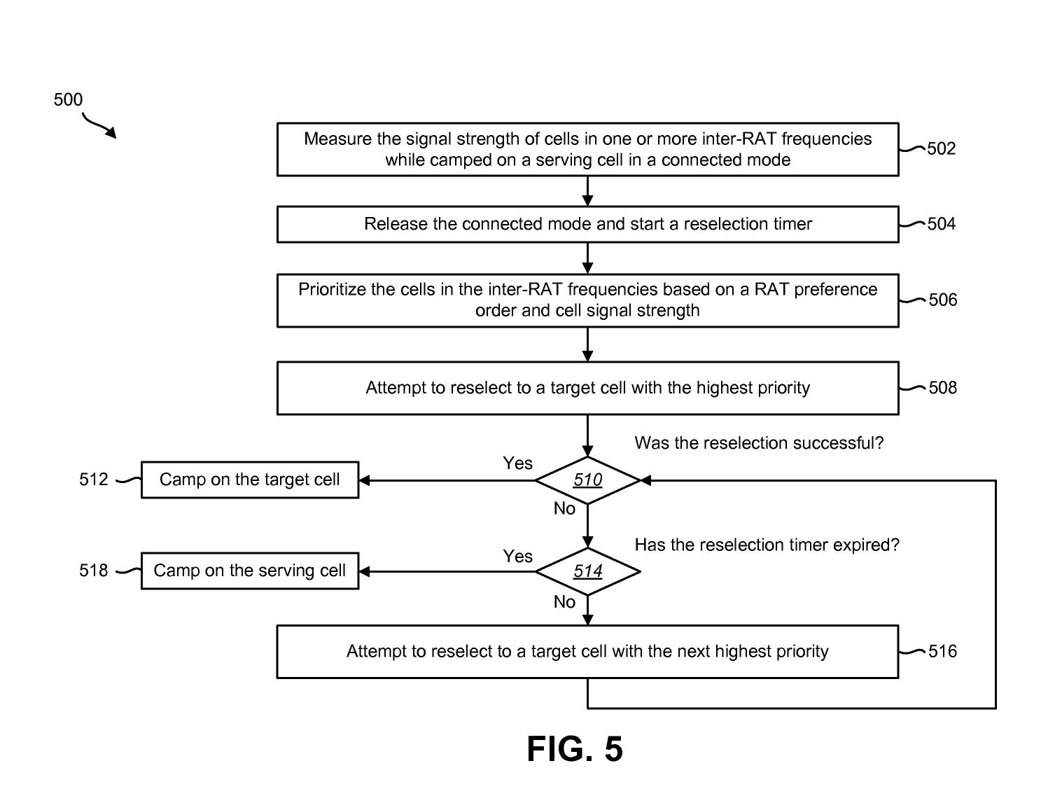

FIG. 5 is a flow diagram illustrating a detailed configuration of a method 500 for inter-RAT reselection. The method 500 may be performed by a wireless communication device 102. The wireless communication device 102 may be camped on a serving cell 104.

While camped on the serving cell 104 in connected mode (e.g., dedicated mode or packet transfer mode), the wireless communication device 102 may measure 502 the signal strength 114 of cells in one or more inter-RAT frequencies 112. The wireless communication device 102 may measure the cell signal strength 114 for the one or more cells (e.g., neighbor cells 106) in an inter-RAT frequency 112. For example, while in a voice or data call, the wireless communication device 102 may measure the cell signal strengths 114 associated with one or more inter-RAT frequencies 112. The cell signal strength 114 may be an RSRP RSSI or RSCP for a neighbor cell 106.

At the end of the voice or data call, the wireless communication device 102 may release 504 connected mode. The wireless communication device 102 may start a reselection timer 124.

Before the wireless communication device 102 moves to idle mode on the serving cell 104, the wireless communication device 102 may prioritize 506 the cells in the one or more inter-RAT frequencies 112 based on a RAT preference order 118 and cell signal strength 114. This may be accomplished as described in connection with FIG. 3.

The wireless communication device 102 may attempt 508 to reselect to a highest priority cell. For example, the wireless communication device 102 may attempt 508 to reselect to the target cell 126 with the highest priority when the target cell 126 belongs to a more-preferred RAT 108 than the RAT 108 of the serving cell 104. The wireless communication device 102 may attempt 508 to reselect to the target cell 126 if the signal strength 114 of the target cell 126 meets the cell selection criterion for the RAT 108 of the target cell 126.

The wireless communication device 102 may determine 510 whether the reselection was successful. If the reselection was successful, then the wireless communication device 102 may camp on the target cell 126.

If the wireless communication device 102 determines 510 that the reselection was not successful, then the wireless communication device 102 may determine 514 whether the reselection timer 124 has expired. If the reselection timer 124 has not expired, then the wireless communication device 102 may attempt 516 to reselect to a target cell 126 with the next highest priority. For example, if the reselection to the target cell 126 with the highest priority fails, then the wireless communication device 102 may attempt 516 to reselect to a target cell 126 with the second highest priority.

The wireless communication device 102 may determine 510 whether the additional reselection was successful. If this reselection was successful, the wireless communication device 102 may camp 512 on the target cell 126. If the reselection was not successful, the wireless communication device 102 may continue to attempt to reselect to a target cell 126 based on priority until the reselection timer 124 expires.

When the wireless communication device 102 determines 514 that the reselection timer 124 expires, the wireless communication device 102 may camp 518 on the serving cell 104. Upon camping 518 back on the serving cell 104, the wireless communication device 102 may then enter idle mode.

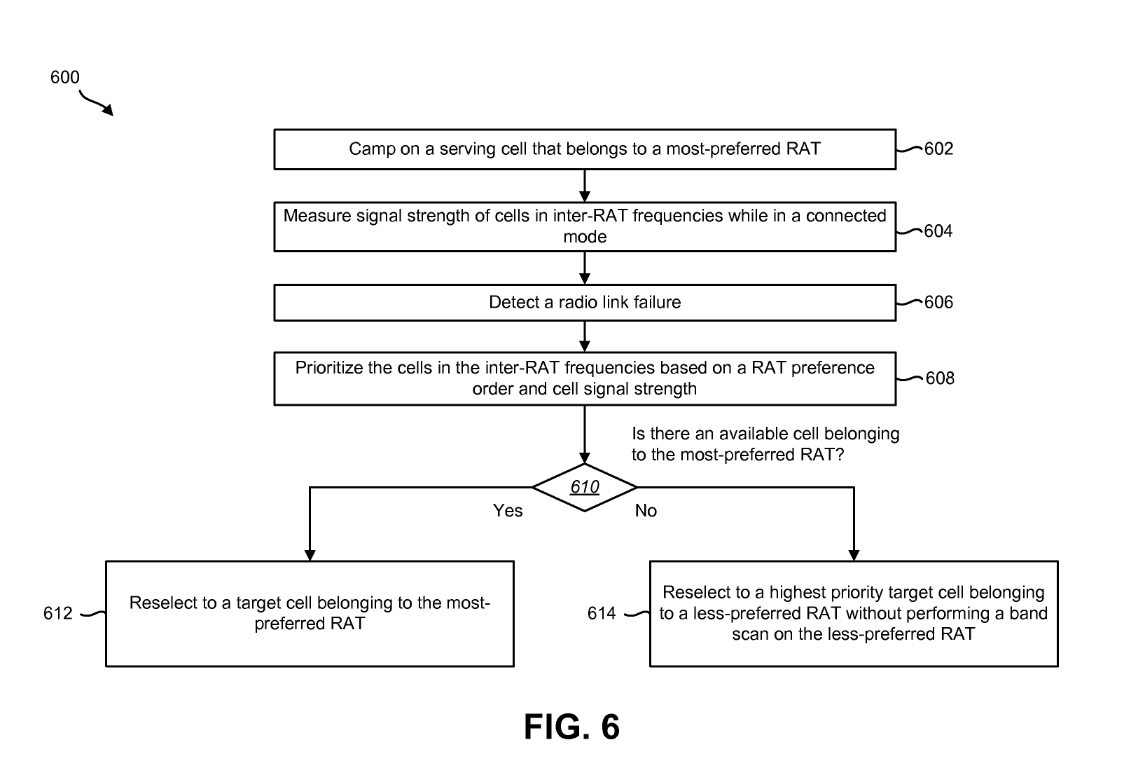

FIG. 6 is a flow diagram illustrating a detailed configuration of a method 600 for inter-RAT reselection. The method 600 may be performed by a wireless communication device 102.

The wireless communication device 102 may camp 602 on a serving cell 104 that belongs to a most-preferred RAT 108. For example, the serving cell 104 may belong to the most-preferred RAT 108 of a RAT preference order 118.

The wireless communication device 102 may measure 604 signal strength 114 of cells in one or more inter-RAT frequencies 112 while in connected mode. For example, while in a voice or data call, the wireless communication device 102 may measure cell signal strength 114 associated with one or more inter-RAT frequencies 112.

The wireless communication device 102 may detect 606 a radio link failure. The radio link failure may be a break in the physical layer between the wireless communication device 102 and the serving cell 104. For example, in a very weak signal area, the measured RSRP of the serving cell 104 may be below a certain threshold.

The wireless communication device 102 may prioritize 606 the cells in the one or more inter-RAT frequencies 112 based on a RAT preference order 118 and the measured cell signal strength 114. This may be accomplished as described in connection with FIG. 3. The priority of the cells may be indicated in an inter-RAT cell priority list 120.

The wireless communication device 102 may determine 610 whether there is an available cell belonging to the most-preferred RAT 108. For example, the wireless communication device 102 may determine whether any detected neighbor cells 106 belong to the same RAT 108 as the serving cell 104. If there is an available neighbor cell 106 that belongs to the most-preferred RAT 108, then the wireless communication device 102 may reselect 612 to a target cell 126 belonging to the most-preferred RAT 108.

If the wireless communication device 102 determines 610 that there are no available cells belonging to the most-preferred RAT 108, then the wireless communication device 102 may reselect 614 to a highest priority target cell 126 belonging to a less-preferred RAT 108. The priority of the target cell 126 may be determined based on the inter-RAT cell priority list 120. The wireless communication device 102 may perform reselection to the target cell 126 on the less-preferred RAT 108 without performing a band scan on the less-preferred RAT 108. In other words, because the wireless communication device 102 has already measured signal strength 114 of cells in the inter-RAT frequencies 112, the wireless communication device 102 has knowledge of the availability of inter-RAT neighbor cells 106. Therefore, the wireless communication device 102 may withhold performing a band scan on the less-preferred RAT 108 and may attempt to reselect 614 to a target cell 126 with the highest priority inter-RAT frequency 112.

In one example, the most-preferred RAT 108 may be LTE and a less-preferred RAT 108 may be GERAN. The wireless communication device 102 may be camped on an LTE serving cell 104. While in connected mode on the LTE serving cell 104, the wireless communication device 102 may measure one or more GERAN neighbor cells 106. The wireless communication device 102 may then experience a radio link failure. Upon determining that there are no available LTE neighbor cells 106, the wireless communication device 102 may reselect to the highest priority GERAN neighbor cell 106 without performing a band scan on GERAN.

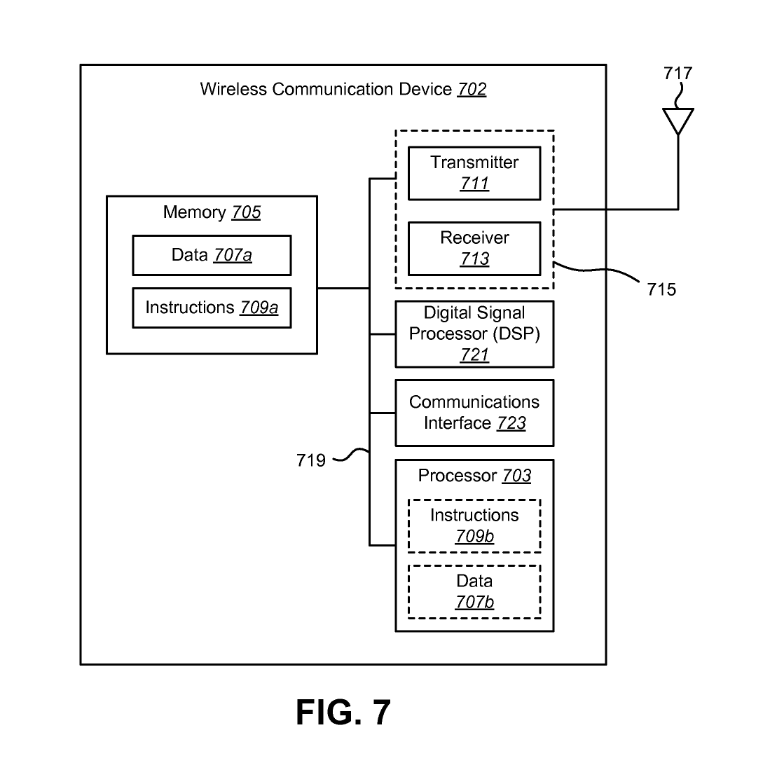

FIG. 7 illustrates certain components that may be included within a wireless communication device 702. The wireless communication device 702 may be an access terminal, a mobile station, a user equipment (UE), etc. For example, the wireless communication device 702 may be the wireless communication device 102 of FIG. 1.

The wireless communication device 702 includes a processor 703. The processor 703 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 702 of FIG. 7, in an alternative configuration, a combination of processors (e.g., an ARM and DSP) could be used.

The wireless communication device 702 also includes memory 705. The memory 705 may be any electronic component capable of storing electronic information. The memory 705 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 707a and instructions 709a may be stored in the memory 705. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The wireless communication device 702 may also include a transmitter 711 and a receiver 713 to allow transmission and reception of signals to and from the wireless communication device 702 via an antenna 717. The transmitter 711 and receiver 713 may be collectively referred to as a transceiver 715. The wireless communication device 702 may also include (not shown) multiple transmitters, multiple antennas, multiple receivers and/or multiple transceivers.

The wireless communication device 702 may include a digital signal processor (DSP) 721. The wireless communication device 702 may also include a communications interface 723. The communications interface 723 may allow a user to interact with the wireless communication device 702.

The various components of the wireless communication device 702 may be coupled together by one or more buses, which may include a power bus, a control signal bus, a status signal bus, a data bus, etc. For the sake of clarity, the various buses are illustrated in FIG. 7 as a bus system 719.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

As used herein, the phrase “at least one of” preceding a series of items, with the term “and” or “or” to separate any of the items, modifies the list as a whole, rather than each member of the list (i.e., each item). The phrase “at least one of does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The functions described herein may be implemented in software or firmware being executed by hardware. The functions may be stored as one or more instructions on a computer-readable medium. The terms “computer-readable medium” or “computer-program product” refer to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, FIG. 3, FIG. 5, and FIG. 6 can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for cell reselection, comprising:
measuring signal strength of cells in one or more inter-radio access technology (inter-RAT) frequencies while camped on a serving cell in a connected mode;
on releasing the connected mode and before moving to idle mode on the serving cell:
prioritizing the cells in the one or more inter-RAT frequencies based on a RAT preference order and the signal strength; and
reselecting to a highest priority cell whose signal strength meets a cell selection criterion.

2. The method of claim 1, wherein the connected mode comprises a dedicated mode or a packet transfer mode.

3. The method of claim 1, wherein the RAT preference order ranks multiple RATs from most-preferred RAT to least-preferred RAT for inter-RAT cell reselection.

4. The method of claim 1, wherein the RAT preference order is user-defined or preconfigured by a wireless communication device manufacturer.

5. The method of claim 1, wherein prioritizing the cells in the one or more inter-RAT frequencies comprises:
sorting the cells in the one or more inter-RAT frequencies into one or more RAT groups, wherein cells belonging to the same RAT are included in the same RAT group;
sorting the one or more RAT groups according to the RAT preference order, wherein a more-preferred RAT has a higher priority than a less-preferred RAT; and
sorting cells within each RAT group according to signal strength, wherein a cell with a higher signal strength has a higher priority than a cell with a lower signal strength.

6. The method of claim 1, further comprising reselecting to the highest priority cell when the highest priority cell belongs to a more-preferred RAT than the RAT of the serving cell.

7. The method of claim 1, further comprising camping back on the serving cell if reselecting to one or more target cells on a more-preferred RAT fails before expiration of a reselection timer.

8. The method of claim 1, wherein if the serving cell belongs to a most-preferred RAT, then upon radio link failure (RLF) and when there are no available cells belonging to the most-preferred RAT, the method further comprises reselecting to the highest priority cell belonging to a less-preferred RAT without performing a band scan on the less-preferred RAT.

9. The method of claim 1, wherein the serving cell is a shared cell.

10. A wireless communication device for cell reselection, comprising:
a processor;
memory in electronic communication with the processor; and
instructions stored in the memory, the instructions being executable by the processor to:
measure signal strength of cells in one or more inter-radio access technology (inter-RAT) frequencies while camped on a serving cell in a connected mode;
on releasing the connected mode and before moving to idle mode on the serving cell:
prioritize the cells in the one or more inter-RAT frequencies based on a RAT preference order and the signal strength; and
reselect to a highest priority cell whose signal strength meets a cell selection criterion.

11. The wireless communication device of claim 10, wherein the RAT preference order ranks multiple RATs from most-preferred RAT to least-preferred RAT for inter-RAT cell reselection.

12. The wireless communication device of claim 10, wherein the RAT preference order is user-defined or preconfigured by a wireless communication device manufacturer.

13. The wireless communication device of claim 1, wherein the instructions executable to prioritize the cells in the one or more inter-RAT frequencies comprise instructions executable to:
sort the cells in the one or more inter-RAT frequencies into one or more RAT groups, wherein cells belonging to the same RAT are included in the same RAT group;
sort the one or more RAT groups according to the RAT preference order, wherein a more-preferred RAT has a higher priority than a less-preferred RAT; and
sort cells within each RAT group according to signal strength, wherein a cell with a higher signal strength has a higher priority than a cell with a lower signal strength.

14. The wireless communication device of claim 10, further comprising instructions executable to reselect to the highest priority cell when the highest priority cell belongs to a more-preferred RAT than the RAT of the serving cell.

15. The wireless communication device of claim 10, further comprising instructions executable to camp back on the serving cell if reselecting to one or more target cells on a more-preferred RAT fails before expiration of a reselection timer.

16. The wireless communication device of claim 10, wherein if the serving cell belongs to a most-preferred RAT, then upon radio link failure (RLF) and when there are no available cells belonging to the most-preferred RAT, the instructions are further executable to reselect to the highest priority cell belonging to a less-preferred RAT without performing a band scan on the less-preferred RAT.

17. An apparatus for cell reselection, comprising:
means for measuring signal strength of cells in one or more inter-radio access technology (inter-RAT) frequencies while camped on a serving cell in a connected mode;
on releasing the connected mode and before moving to idle mode on the serving cell:
means for prioritizing the cells in the one or more inter-RAT frequencies based on a RAT preference order and the signal strength; and
means for reselecting to a highest priority cell whose signal strength meets a cell selection criterion.

18. The apparatus of claim 17, wherein the RAT preference order ranks multiple RATs from most-preferred RAT to least-preferred RAT for inter-RAT cell reselection.

19. The apparatus of claim 17, wherein the RAT preference order is user-defined or preconfigured by a wireless communication device manufacturer.

20. The apparatus of claim 17, wherein the means for prioritizing the cells in the one or more inter-RAT frequencies comprise:
means for sorting the cells in the one or more inter-RAT frequencies into one or more RAT groups, wherein cells belonging to the same RAT are included in the same RAT group;
means for sorting the one or more RAT groups according to the RAT preference order, wherein a more-preferred RAT has a higher priority than a less-preferred RAT; and
means for sorting cells within each RAT group according to signal strength, wherein a cell with a higher signal strength has a higher priority than a cell with a lower signal strength.

21. The apparatus of claim 17, further comprising means for reselecting to the highest priority cell when the highest priority cell belongs to a more-preferred RAT than the RAT of the serving cell.

22. The apparatus of claim 17, further comprising means for camping back on the serving cell if reselecting to one or more target cells on a more-preferred RAT fails before expiration of a reselection timer.

23. The apparatus of claim 17, wherein if the serving cell belongs to a most-preferred RAT, then upon radio link failure (RLF) and when there are no available cells belonging to the most-preferred RAT, the apparatus further comprises means for reselecting to the highest priority cell belonging to a less-preferred RAT without performing a band scan on the less-preferred RAT.

24. A computer-program product for cell reselection, the computer-program product comprising a non-transitory computer-readable medium having instructions thereon, the instructions comprising:
code for causing a wireless communication device to signal strength of cells in one or more inter-radio access technology (inter-RAT) frequencies while camped on a serving cell in a connected mode;
on releasing the connected mode and before moving to idle mode on the serving cell:
code for causing the wireless communication device to prioritize the cells in the one or more inter-RAT frequencies based on a RAT preference order and the signal strength; and
code for causing the wireless communication device to reselect to a highest priority cell whose signal strength meets a cell selection criterion.

25. The computer-program product of claim 24, wherein the RAT preference order ranks multiple RATs from most-preferred RAT to least-preferred RAT for inter-RAT cell reselection.

26. The computer-program product of claim 24, wherein the RAT preference order is user-defined or preconfigured by a wireless communication device manufacturer.

27. The computer-program product of claim 24, wherein the code for causing the wireless communication device to prioritize the cells in the one or more inter-RAT frequencies comprises:
code for causing the wireless communication device to sort the cells in the one or more inter-RAT frequencies into one or more RAT groups, wherein cells belonging to the same RAT are included in the same RAT group;
code for causing the wireless communication device to sort the one or more RAT groups according to the RAT preference order, wherein a more-preferred RAT has a higher priority than a less-preferred RAT; and
code for causing the wireless communication device to sort cells within each RAT group according to signal strength, wherein a cell with a higher signal strength has a higher priority than a cell with a lower signal strength.

28. The computer-program product of claim 24, further comprising code for causing the wireless communication device to reselect to the highest priority cell when the highest priority cell belongs to a more-preferred RAT than the RAT of the serving cell.

29. The computer-program product of claim 24, further comprising code for causing the wireless communication device to camp back on the serving cell if reselecting to one or more target cells on a more-preferred RAT fails before expiration of a reselection timer.

30. The computer-program product of claim 24, wherein if the serving cell belongs to a most-preferred RAT, then upon radio link failure (RLF) and when there are no available cells belonging to the most-preferred RAT, the computer-program product further comprises code for causing the wireless communication device to reselect to the highest priority cell belonging to a less-preferred RAT without performing a band scan on the less-preferred RAT.
